(19) United States
(12) Patent Application Publication
(10) Pub. No.: US 2017/0171745 A1
(43) Pub. Date: Jun. 15, 2017

(54) PRIVACY PROTECTION IN WIRELESS NETWORKS

(71) Applicant: QUALCOMM Incorporated, San Diego, CA (US)

(72) Inventor: Alfred ASTERJADHI, San Diego, CA (US)

(21) Appl. No.: 15/373,365

(22) Filed: Dec. 8, 2016

Related U.S. Application Data
(60) Provisional application No. 62/265,396, filed on Dec. 9, 2015.

(51) Int. Cl. H04W 12/02; H04W 8/26; H04W 76/02

(52) U.S. Cl. CPC H04W 12/02; H04W 76/021; H04W 8/26

(57) ABSTRACT

Certain aspects of the present disclosure generally relate to wireless communications and, more particularly, to techniques that may help provide privacy in wireless communications. The techniques may include obtaining, from a wireless node, a first frame having an encoded portion with information regarding a second identification (ID), different than a first ID already assigned to an apparatus, decrypting the information regarding the second ID, using the second ID as a transmitter address when generating frames intended for the wireless node, using the second ID as a receiver address when processing frames obtained from the wireless node, and outputting the frames intended for the wireless node for transmission.

### CLAIM OF PRIORITY UNDER 35 U.S.C. §119

The present Application for Patent claims benefit of U.S. Provisional Patent Application Ser. No. 62/265,396, filed Dec. 9, 2015, assigned to the assignee hereof and hereby expressly incorporated by reference herein.

### FIELD OF THE DISCLOSURE

Certain aspects of the present disclosure generally relate to wireless communications and, more particularly, to privacy protection in wireless networks using dynamically assigned identifications (IDs).

### DESCRIPTION OF RELATED ART

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In wireless local area networks (WLANs), a typical media access control (MAC) Data frame, defined by the IEEE 802.11 family of standards, includes a field for an address of the source/transmitter of the frame, as well as a field for an address of the intended/target recipient. Unfortunately, because these frames are transmitted over the air, the content of these address fields may be observed by third party devices (so-called “sniffers” that “sniff” information in transmissions intended for other devices) and used to perform malicious acts. For example, by observing the MAC address of a transmitting device, a third party device may attempt to jam a channel to prevent transmissions to/from that MAC address (e.g., by transmitting interfering transmissions that keep the transmissions from being successfully received and/or keep a transmitting device from gaining access to the channel for transmission).

### SUMMARY

Certain aspects of the present disclosure provide an apparatus for wireless communications. The apparatus generally includes a first interface configured to obtain, from a wireless node, a first frame having an encoded portion with information regarding a second identification (ID), different than a first ID already assigned to the apparatus, a processing system configured to decode the information regarding the second ID, to use the second ID as a transmitter address when generating frames intended for the wireless node, and to use the second ID as a receiver address when processing frames obtained from the wireless node, and a second interface configured to output the frames intended for the wireless node for transmission.

Certain aspects of the present disclosure provide an apparatus for wireless communications. The apparatus generally includes a processing system configured to generate a first frame having an encoded portion with information regarding a second identification (ID), different than a first ID already assigned to a wireless node, to use the second ID as a receiver address when generating frames intended for the wireless node, and to use the second ID as a transmitter address when processing frames obtained from the wireless node and a first interface configured to output the first frame and other frames intended for the wireless node for transmission.

Certain aspects also provide various methods, apparatuses, and computer program products capable of performing operations corresponding to those described above.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a diagram of an example wireless communications network, in accordance with certain aspects of the present disclosure.

FIG. 2 illustrates a block diagram of an example access point (AP) and user terminals (UTs), in accordance with certain aspects of the present disclosure.

FIG. 3 illustrates a block diagram of an example wireless node, in accordance with certain aspects of the present disclosure.

FIG. 4 illustrates an example communications session using a protected ID, in accordance with aspects of the present disclosure.

FIG. 5 sets forth example operations for wireless communications by a station, in accordance with certain aspects of the present disclosure.

FIG. 5A illustrates example means capable of performing the operations set forth in FIG. 5.

FIG. 6 sets forth example operations for wireless communications by a station, in accordance with certain aspects of the present disclosure.

FIG. 6A illustrates example means capable of performing the operations set forth in FIG. 6.

FIG. 7 illustrates an example frame for providing a protected ID, in accordance with certain aspects of the present disclosure.

FIG. 8 illustrates an example frame using a protected ID, in accordance with certain aspects of the present disclosure.

### DETAILED DESCRIPTION

As noted above, because frames are transmitted over the air in 802.11 systems, the content of address fields may be observed and used to perform malicious acts. In current wireless networks (802.11) the STAs send frames that contain the MAC address. Hence, a third party STA may be able to determine which STA is sending a frame and as such can gather information of a particular station (e.g., type of traffic, wake up patterns, and the like) and use this information, for example, to perform denial of service (DoS).

Rather than use conventionally assigned MAC addresses or AIDs, aspects of the present disclosure allow a device to request a “re-assigned” ID through a secure negotiation. By providing this re-assigned ID in an encoded format, only the intended recipient may have knowledge of its value. Thus, other (e.g., sniffing) devices may not recognize the re-assigned ID when used as a source or target address in transmissions, which may help avoid malicious attacks. As used herein, the term encoded generally refers to any type of encoding, whether transmitting and receiving devices know encoding parameters in advance, or encryption, which may imply transmitting and receiving devices do not know in advance what encoding parameters are used (which may help ensure confidentiality of the transmitted information). Similarly, the term decoding generally refers to any type of decoding, including decryption.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

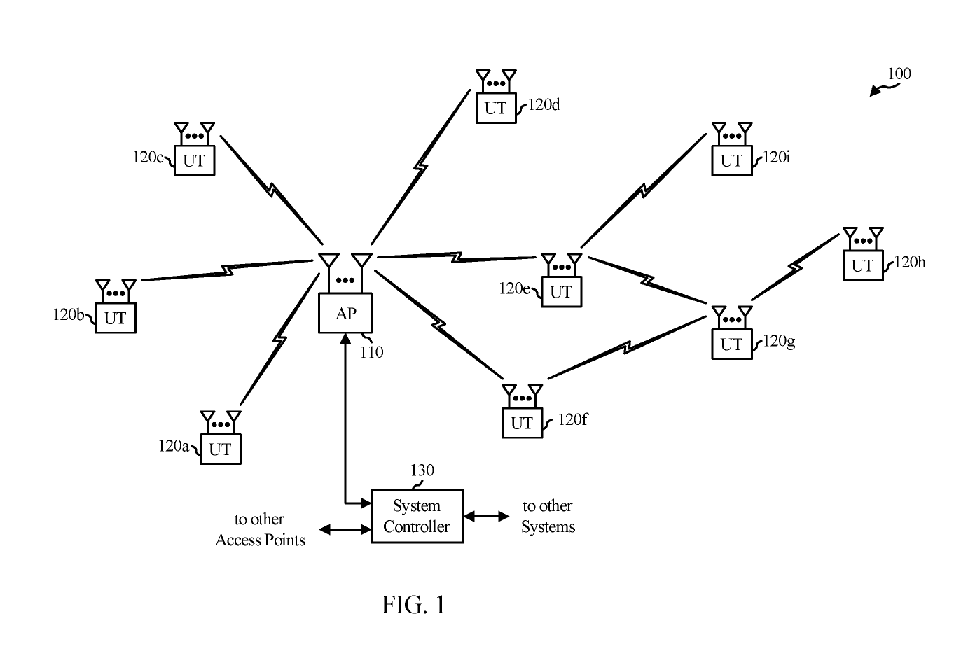

FIG. 1 illustrates a multiple-access multiple-input multiple-output (MIMO) system 100 with access points and user terminals in which aspects of the present disclosure may be practiced. For example, one or more user terminals 120 may signal capabilities (e.g., to access point 110) using the techniques provided herein.

For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device, or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an AP 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The access point 110 and user terminals 120 employ multiple transmit and multiple receive antennas for data transmission on the downlink and uplink. For downlink MIMO transmissions, Nₐₚ antennas of the access point 110 represent the multiple-input (MI) portion of MIMO, while a set of K user terminals represent the multiple-output (MO) portion of MIMO. Conversely, for uplink MIMO transmissions, the set of K user terminals represent the MI portion, while the Nₐₚ antennas of the access point 110 represent the MO portion. For pure SDMA, it is desired to have Nₐₚ≧K≧1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

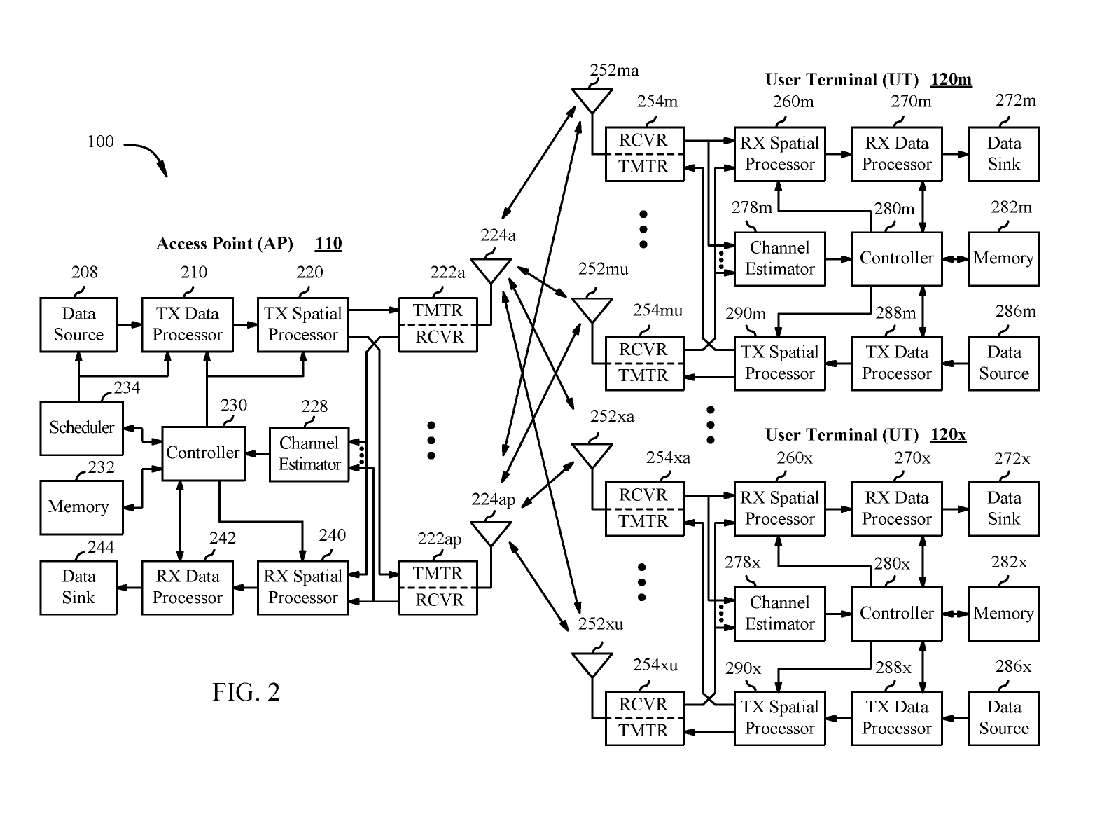

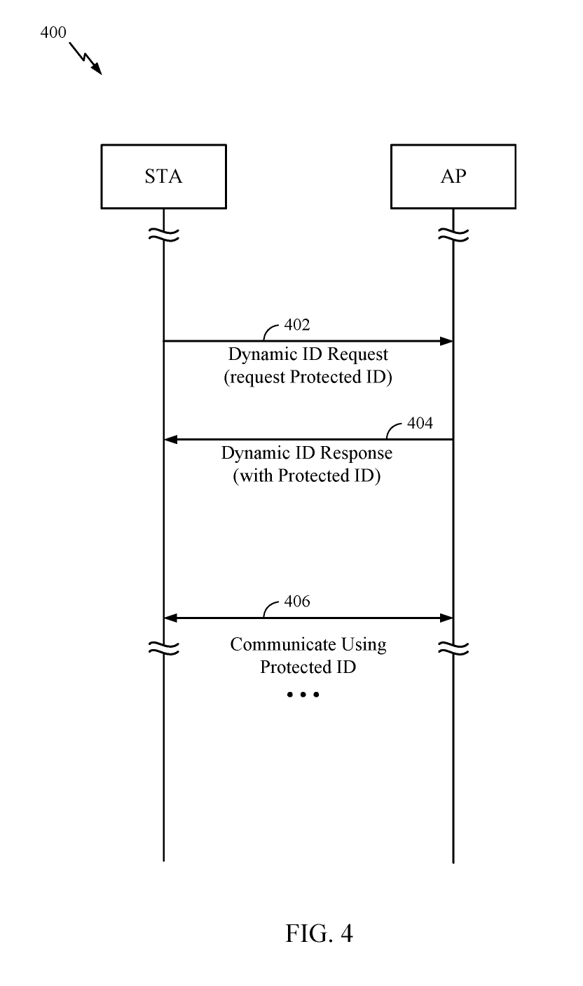

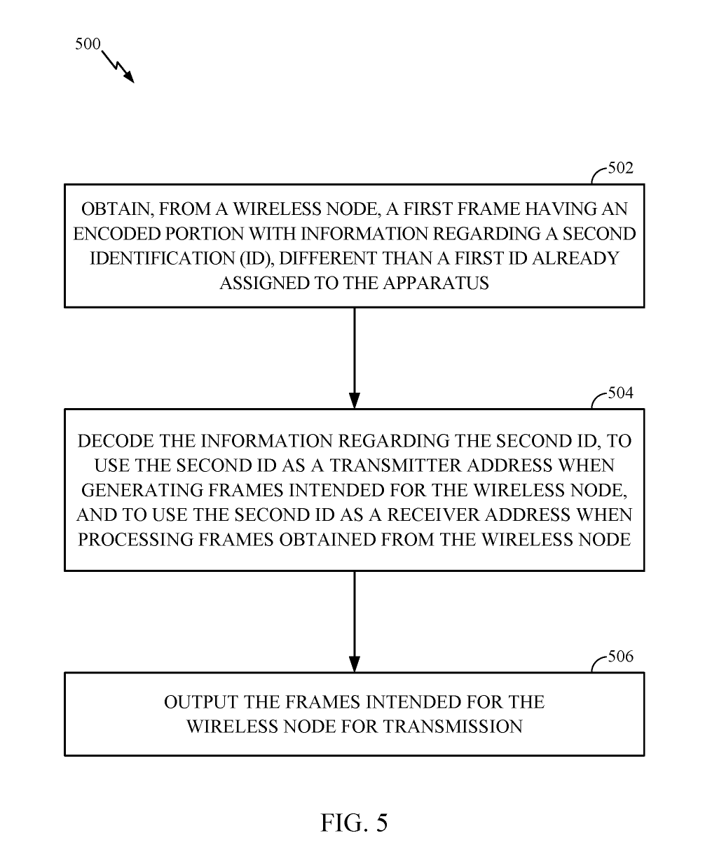

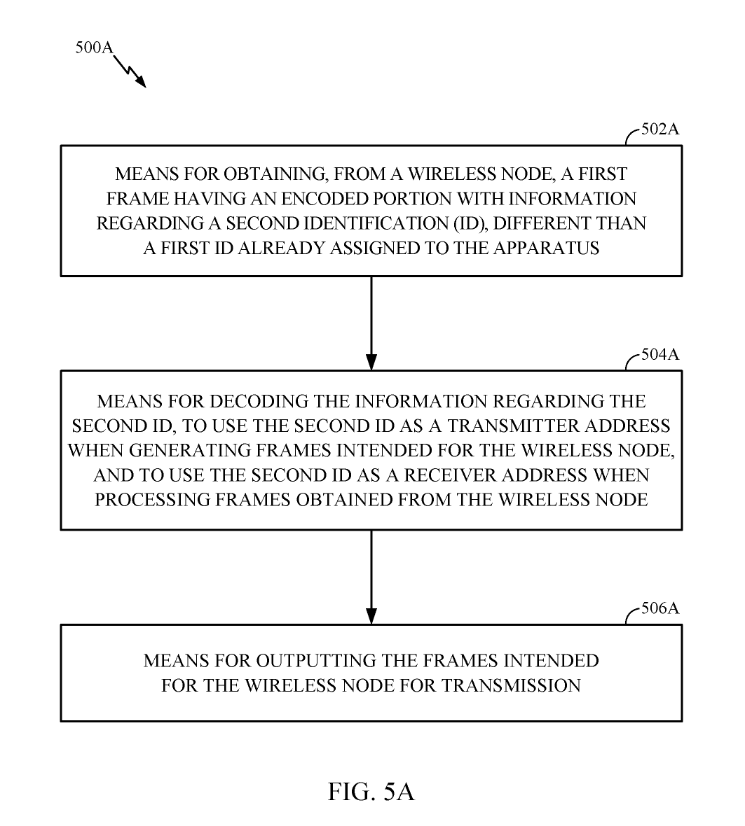

FIG. 2 illustrates a block diagram of access point 110 and two user terminals 120m and 120x in MIMO system 100 that may be examples of the access point 110 and user terminals 120 described above with reference to FIG. 1 and capable of performing the techniques described herein. The various processors shown in FIG. 2 may be configured to perform (or direct a device to perform) various methods described herein, for example, the operations 400 and 500 described in association with FIGS. 4 and 5.

The access point 110 is equipped with Nₜ antennas 224a through 224t. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink. For SDMA transmissions, Nᵤₚ user terminals simultaneously transmit on the uplink, while N_{dn} user terminals are simultaneously transmitted to on the downlink by the access point 110. Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a transmit (TX) data processor 288 receives traffic data from a data source 286 and control data from a controller 280. The controller 280 may be coupled with a memory 282. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing. The controller 230 may be coupled with a memory 232.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal. The decoded data for each user terminal may be provided to a data sink 272 for storage and/or a controller 280 for further processing.

At each user terminal 120, a channel estimator 278 estimates the downlink channel response and provides downlink channel estimates, which may include channel gain estimates, SNR estimates, noise variance and so on. Similarly, at access point 110, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

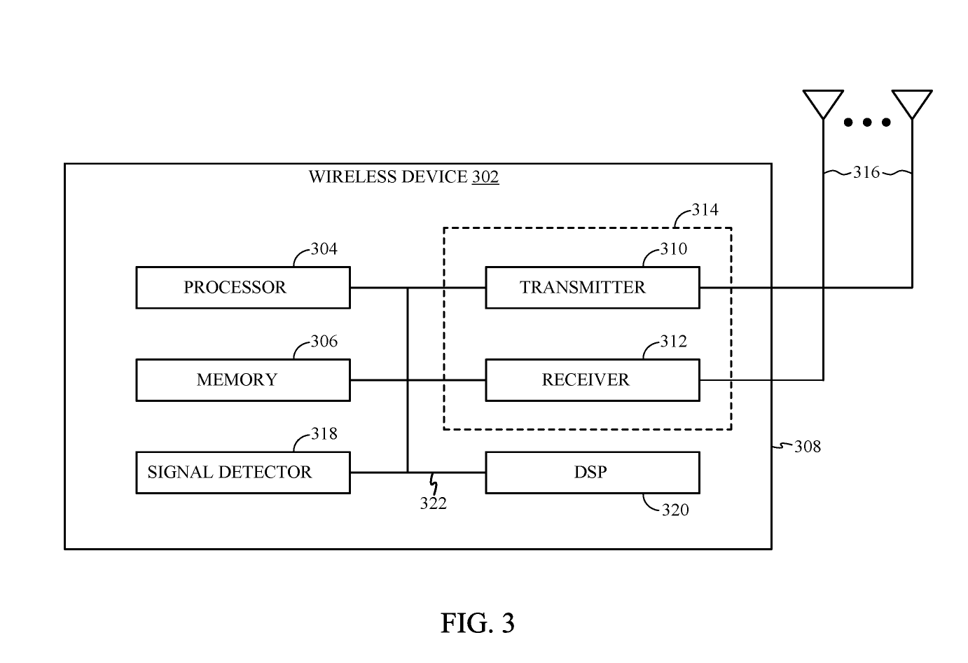

FIG. 3 illustrates example components that may be utilized in AP 110 and/or UT 120 to implement aspects of the present disclosure. For example, the transmitter 310, antenna(s) 316, processor 304, and/or DSP 320 may be used to practice aspects of the present disclosure implemented by an AP or UT, such as operation 400 described in association with FIG. 4 below. Further, the receiver 312, antenna(s) 316, processor 304, and/or the DSP 320 may be used to practice aspects of the present disclosure implemented by an AP or UT, such as operation 500 described in association with FIG. 5. The wireless node (e.g., wireless device) 302 may be an access point 110 or a user terminal 120.

The wireless node (e.g., wireless device) 302 may include a processor 304 which controls operation of the wireless node 302. The processor 304 may also be referred to as a central processing unit (CPU). The processor 304 may control the wireless node 302 in executing the various methods described herein, for example, the operations 400 and 500 described in association with FIGS. 4 and 5. Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein, for example, the operations 400 and 500 described in association with FIGS. 4 and 5.

The wireless node 302 may also include a housing 308 that may include a transmitter 310 and a receiver 312 to allow transmission and reception of data between the wireless node 302 and a remote node. The transmitter 310 and receiver 312 may be combined into a transceiver 314. A single transmit antenna or a plurality of transmit antennas 316 may be attached to the housing 308 and electrically coupled to the transceiver 314. The wireless node 302 may also include (not shown) multiple transmitters, multiple receivers, and multiple transceivers.

The wireless node 302 may use multiple transmitters, multiple receivers, and/or multiple transceivers in communicating with a WWAN and one or more WLANs. Additionally or alternatively, the wireless node 302 may communicate with a WWAN via a single transmitter 310, a single receiver 312, and/or a single transceiver 314 and retune the transmitter 310, receiver 312, and/or transceiver 314 (tune away from the WWAN) to communicate with one or more WLANs.

The wireless node 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless node 302 may also include a digital signal processor (DSP) 320 for use in processing signals.

The various components of the wireless node 302 may be coupled together by a bus system 322, which may include a power bus, a control signal bus, and a status signal bus in addition to a data bus.

In general, an AP and STA may perform similar (e.g., symmetric or complementary) operations. Therefore, for many of the techniques described herein, an AP or STA may perform similar operations. To that end, the following description will sometimes refer to an “AP/STA” to reflect that an operation may be performed by either. Although, it should be understood that even if only “AP” or “STA” is used, it does not mean a corresponding operation or mechanism is limited to that type of device.

### Example Privacy Protection in Wireless Networks

As noted above, rather than use conventionally assigned MAC addresses or AIDs, aspects of the present disclosure allow a device to request a “re-assigned” ID through a secure negotiation. By providing this re-assigned ID in an encrypted format, only the intended recipient may have knowledge of its value, which may help avoid malicious attacks by other devices (acting as a so-called “man in the middle”). This ID may be used as a receiver address (RA) or transmitter address (TA) in a packet, rather than a MAC ID or an AID (assigned to a STA by an AP during association).

FIG. 4 illustrates an example communications session, in which a station (STA) and AP negotiate a protected ID, in accordance with aspects of the present disclosure.

As illustrated, at 402, the STA (which may have already associated with the AP and assigned an ID) may send a request for a protected ID (e.g., this may be referred to as a Dynamic ID Request). At 404, the AP may send a response carrying a “re-assigned” protected ID. The protected ID may be encrypted such that only the STA can decrypt the protected ID, thus preventing third party devices from learning its value.

In some cases, the STA may be configured to send a request for a new (protected) ID upon a trigger event. For example, if the STA experiences denial of service (a denial of service attack), the STA may request a new ID.

In some cases, a STA may be configured with multiple protected IDs and the AP may recognize any of these IDs as an ID of the STA. In such cases, the STA may be configured to randomly select one of the multiple protected IDs when transmitting to the AP (and similarly, the AP may randomly select one of the multiple protected IDs when transmitting to the AP). This may help prevent a third party device (e.g., an attacker) from recognizing a traffic pattern and possibly learning the STA (potentially under attack) is using a protected ID (and carrying out an attack). In other words, using different protected IDs may provide sufficient variation such that a pattern is not detected.

In some cases, an AP may allocate a common ID for use by multiple devices. In the event that jamming is detected, the AP may indicate a STA (under attack) is to use this common ID. In such cases, the correct ID (e.g., MAC address or protected ID) of the STA (under attack) could be carried in an encrypted portion of the packet (allowing for recovery by the AP) In some cases, the STA may be instructed to use the address of the AP (e.g., its own MAC address). This may help thwart a jammer, as the jammer would have to waste a significant amount of power to jam each packet sent with that common ID.

While the example of FIG. 4 shows a STA requesting a protected ID, in some cases, the AP may assign a protected ID to a STA without receiving a request. For example, the AP may send a packet including an encrypted ID any suitable time after association with a STA. In some cases, the AP may proactively assign a protected ID based on a type of traffic that will be sent to/from the STA.

For example, certain types of traffic may be less prone to attacks and/or the impact of losing certain types of transmissions may be greater than for other types. In some cases, an AP send a protected ID after learning of a STA's ability to support dynamic IDs via a capability element (e.g., obtained during association).

As shown at 406, upon successful dynamic ID negotiation, all the traffic intended for the STA and/or generated by the STA may use the protected ID. For example, the protected ID may be used in the appropriate receiver/transmitter address field (e.g., A1 or A2) of a given frame format. For example, the protected ID may be used in place of a MAC address for a protocol version 0 (PV0) frame or in place of an AID for a protocol version 1 (PV1) frame, which may make it very difficult for a third party STA to determine to which STA the particular AID is associated with.

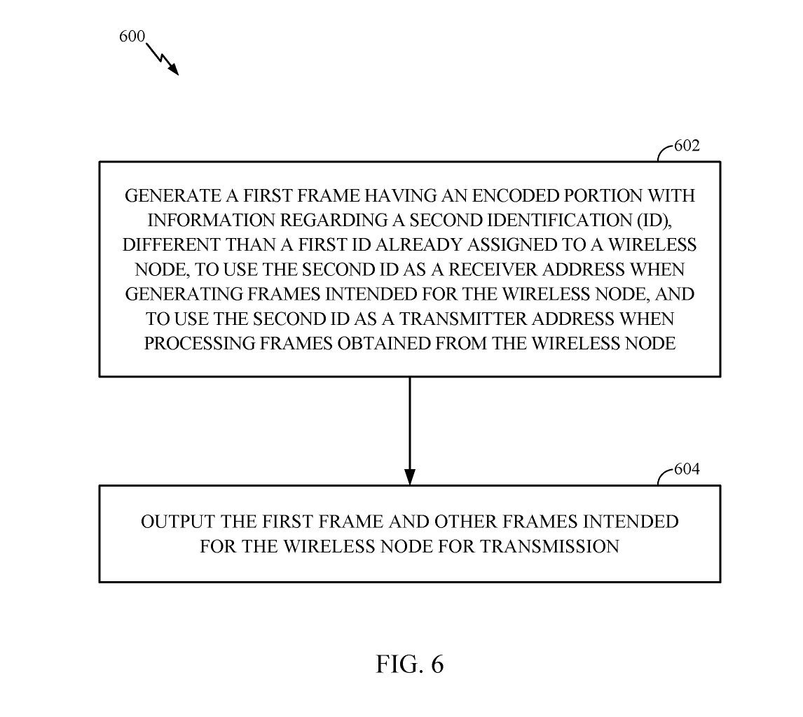

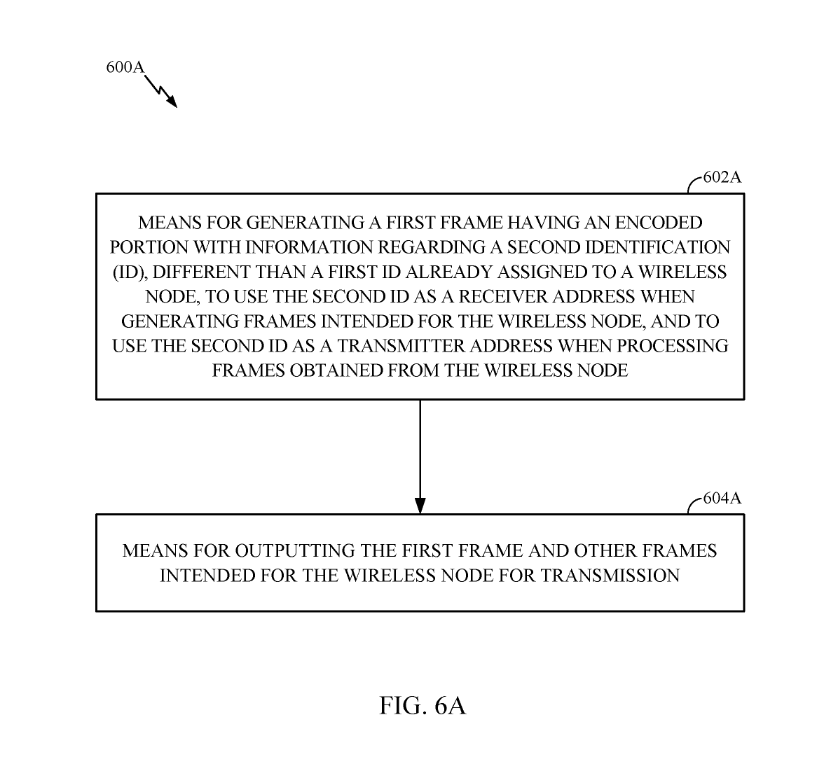

FIGS. 5 and 6 illustrate example operations 500 and 600 that may be performed by the STA and AP, respectively, corresponding to the negotiation shown in FIG. 4.

Operations 500 begin, at 502, with the STA obtaining, from a wireless node (e.g., the AP), a first frame having an encoded (e.g., encrypted) portion with information regarding a second identification (ID), different than a first ID already assigned to the apparatus. At 504, the STA decodes (e.g., decrypts) the information regarding the second ID, to use the second ID as a transmitter address when generating frames intended for the wireless node, and to use the second ID as a receiver address when processing frames obtained from the wireless node. At 506, the STA outputs the frames intended for the wireless node for transmission.

Operations 600 begin, at 602, with the AP generating a first frame having an encoded portion with information regarding a second identification (ID), different than a first ID already assigned to a wireless node, to use the second ID as a receiver address when generating frames intended for the wireless node (e.g., the STA), and to use the second ID as a transmitter address when processing frames obtained from the wireless node. At 604, the AP outputs the first frame and other frames intended for the wireless node for transmission.

As will be described in greater detail, one or both of the request or response may be sent using any suitable encryption protocol. Examples of such protocols include Counter Mode Cipher Block Chaining Message Authentication Code Protocol (CCMP) CCMP or Temporal Key Integrity Protocol (TKIP) that may be used to encrypt at least a payload portion of a response containing information regarding the re-assigned ID. Other types of encryption protocols that may be used include Advanced Encryption Standard (AES) and Galois/Counter Mode Protocol (GCMP). In some cases, a request frame may specify a requested type of encryption/encoding.

In some cases, a STA may use a protected ID, assigned by an AP, for peer-to-peer communications with another STA. In such cases, the AP may assign a protected ID to a first STA and also provide the protected ID to a second STA. The first and second STA may then communicate using the protected ID.

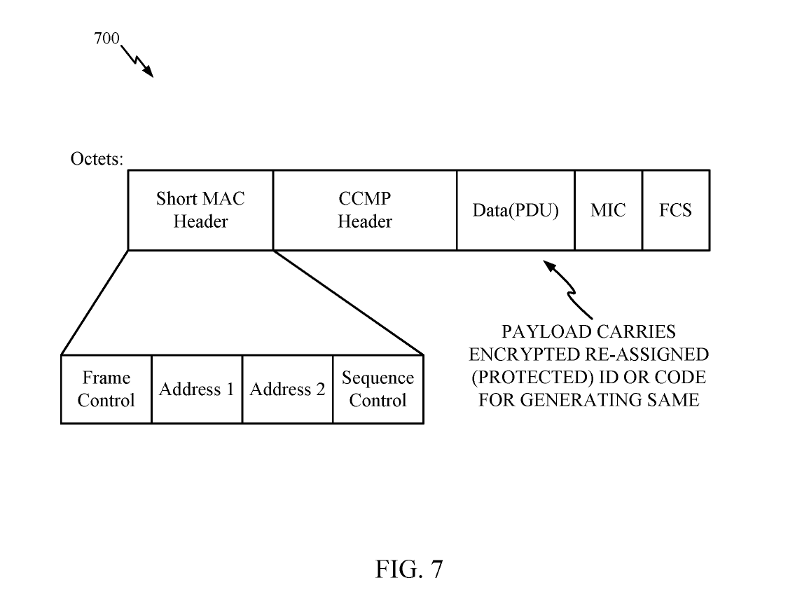

FIG. 7 illustrates an example packet 700 with a CCMP Header and an encrypted payload portion carrying information regarding a protected ID. The packet 700 may be sent by an AP as a response to a dynamic AID request or pro-actively.

As illustrated, the packet 700 may also include a message integrity check (MIC) value and a frame check sequence (FCS). The MIC may be designed to protect both the data payload and header, preventing third parties from conducting bit-flip attacks on encrypted network traffic, by adding a sequence number field to a wireless frame. If frames are received out of order by a wireless access point (e.g., indicating tampering by a third party), then they are subsequently dropped.

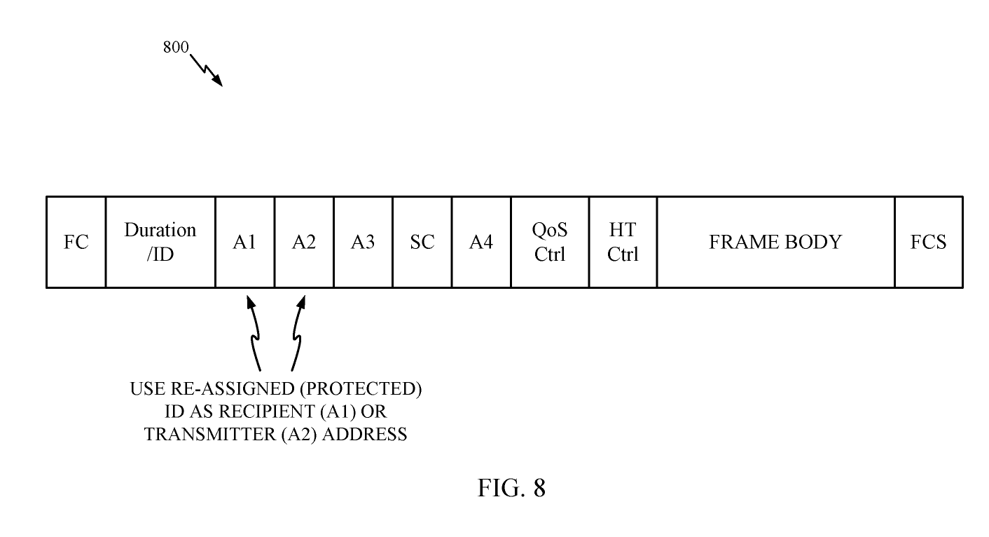

FIG. 8 illustrates an example PV0 frame using a protected ID, in accordance with certain aspects of the present disclosure. As illustrated, the protected ID may be used as the recipient address (A1), for frames intended for the STA, or as the transmitter address (A2), for frames transmitted by the STA.

As described above, the protected ID may be a MAC ID or an AID. In some cases, rather than send the actual protected ID, the AP may provide a code that STA may use to generate the protected ID. For example, may specify a scrambler code or some type of pseudo-random code sequence that the STA may use to generate a protected ID from the STA's MAC ID or assigned AID.

With knowledge of the code, the AP may generate the protected ID to include as a recipient address for frames it generates or for use in confirming a transmitter address for a packet received from a STA.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 500 and 600 illustrated in FIGS. 5 and 6 correspond to means 500A and 600A illustrated in FIGS. 5A and 6A.

Means 500A and/or means 600A may include, for example, controller 280, RX data processor 270, RX spatial processor 260, receiver 254, antenna 252, receiver 312, transceiver 314, signal detector 318, digital signal processor 320, and/or processor 304 shown in FIG. 2 and FIG. 3. Means for obtaining may include components of a receive chain, means for decrypting and means for generating may include a processing system, while means for outputting may include components of a transmit chain.

According to certain aspects, such means may be implemented by processing systems configured to perform the corresponding functions by implementing various algorithms (e.g., in hardware or by executing software instructions) described above for performing fast association. For example, means for decoding and means for generating may be implemented by a (same or different) processing system. Means for obtaining may include an interface, such as a receiver, or interface to obtain frames from a receiver via a bus. Similarly, means for outputting may include an interface, such as a transmitter, or interface to output frames to a transmitter for transmission via a bus

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the term receiver may refer to an RF receiver (e.g., of an RF front end) or an interface (e.g., of a processor) for receiving structures processed by an RF front end (e.g., via a bus). Similarly, the term transmitter may refer to an RF transmitter of an RF front end or an interface (e.g., of a processor) for outputting structures to an RF front end for transmission (e.g., via a bus).

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communications, comprising:
a first interface configured to obtain, from a wireless node, a first frame having an encoded portion with information regarding at least one second identification (ID), different than a first ID already assigned to the apparatus;
a processing system configured to:
decode the information regarding the second ID,
use the second ID as a transmitter address when generating frames intended for the wireless node, and
use the second ID as a receiver address when processing frames obtained from the wireless node; and
a second interface configured to output the frames intended for the wireless node for transmission.

2. The apparatus of claim 1, wherein:
the processing system is configured to generate a second frame requesting the information regarding the second ID;
the second interface is configured to output the second frame for transmission; and
the first frame is obtained in response to the second frame.

3. The apparatus of claim 1, wherein the processing system is configured to decode the encoded portion of the first frame using information in a Counter Mode Cipher Block Chaining Message Authentication Code Protocol (CCMP) header included in the first frame.

4. The apparatus of claim 1, wherein:
the processing system is configured to generate the second ID using at least one code.

5. The apparatus of claim 4, wherein:
the processing system is configured to generate the second ID using the first ID and the at least one code, and the at least one code comprises at least one of a scrambler code or a pseudo-random code sequence.

6. The apparatus of claim 1, wherein:
the second ID comprises at least one of a media access control (MAC) ID or an association ID (AID).

7. The apparatus of claim 6, wherein:
the frames intended for the wireless node comprise at least one of protocol version 0 (PV0) or protocol version 0 (PV1) frames including the MAC ID or the AID as the transmit address.

8. The apparatus of claim 6, wherein:
the frames obtained from the wireless node comprise at least one of protocol version 0 (PV0) or protocol version 0 (PV1) frames including the MAC ID or the AID as the receiver address.

9. The apparatus of claim 1, wherein:
the at least one second ID comprises a plurality of second IDs; and
a processing system configured to:
select one of the second IDs to use as a transmitter address when generating the frames intended for the wireless node, and
select one of the second IDs to use as a receiver address when processing frames obtained from the wireless node.

10. An apparatus for wireless communications, comprising:
a processing system configured to generate a first frame having an encoded portion with information regarding at least one second identification (ID), different than a first ID already assigned to a wireless node, to use the second ID as a receiver address when generating frames intended for the wireless node, and to use the second ID as a transmitter address when processing frames obtained from the wireless node; and
a first interface configured to output the first frame and other frames intended for the wireless node for transmission.

11. The apparatus of claim 10, further comprising:
a second interface configured to obtain, from the wireless node, a second frame requesting the information regarding the second ID; and
wherein the first frame is generated in response to the second frame.

12. The apparatus of claim 10, wherein the processing system is configured to encode the encoded portion of the first frame using Counter Mode Cipher Block Chaining Message Authentication Code Protocol (CCMP) encoding.

13. The apparatus of claim 10, wherein:
the processing system is configured to generate the second ID using at least one code.

14. The apparatus of claim 13, wherein:
the processing system is configured to generate the second ID using the first ID and the at least one code and the at least one code comprises at least one of a scrambler code or a pseudo-random code sequence.

15. The apparatus of claim 10, wherein the second ID comprises at least one of a media access control (MAC) ID or an association ID (AID).

16. The apparatus of claim 15, wherein:
the frames intended for the wireless node comprise at least one of protocol version 0 (PV0) frames or protocol version 1 (PV1) frames including the MAC ID or the AID as the receiver address.

17. The apparatus of claim 15, wherein:
the frames obtained from the wireless node comprise at least one of protocol version 0 (PV0) frames or protocol version 1 (PV1) frames including the MAC ID or the AID as the transmit address.

18. The apparatus of claim 10, wherein:
the at least one second ID comprises a plurality of second IDs; and
a processing system configured to:
select one of the second IDs to use as a transmitter address when processing frames from the wireless node, and
select one of the second IDs to use as a receiver address when generating frames intended for the wireless node.

19. The apparatus of claim 10, wherein the second ID is also allocated to at least one of another wireless node or the apparatus.

20-57. (canceled)

58. A wireless station, comprising:
at least one antenna;
a receiver configured to receive, from a wireless node via the at least one antenna, a first frame having an encoded portion with information regarding at least one second identification (ID), different than a first ID already assigned to the apparatus;
a processing system configured to:
decode the information regarding the second ID,
use the second ID as a transmitter address when generating frames intended for the wireless node, and
use the second ID as a receiver address when processing frames obtained from the wireless node; and
a transmitter configured to transmit, via the at least one antenna, the frames intended for the wireless node for transmission.

59. An access point:
at least one antenna;
a processing system configured to generate a first frame having an encoded portion with information regarding at least one second identification (ID), different than a first ID already assigned to a wireless node, to use the second ID as a receiver address when generating frames intended for the wireless node, and to use the second ID as a transmitter address when processing frames obtained from the wireless node; and
a transmitter configured to transmit, via the at least one antenna, the first frame and other frames intended for the wireless node for transmission.

60-61. (canceled)
